(19) United States
(12) Patent Application Publication
(10) Pub. No.: US 2024/0013602 A1
(43) Pub. Date: Jan. 11, 2024

(54) CHECKOUT DEVICE

(71) Applicant: Toshiba Tec Kabushiki Kaisha, Tokyo (JP)

(72) Inventor: Tsuyoshi GOTANDA, Ota Tokyo (JP)

(21) Appl. No.: 18/332,669

(22) Filed: Jun. 9, 2023

(30) Foreign Application Priority Data
Jul. 11, 2022 (JP) 2022-111394

(51) Int. Cl. G07D 1/06; G07D 9/00; G06Q 20/20; G06Q 20/40

(52) U.S. Cl. CPC G07D 1/06; G07D 9/00; G06Q 20/204; G06Q 20/407; G07D 2201/00

(57) ABSTRACT

A checkout device includes a change machine into which coins can be inserted and from which coins can be dispensed, the change machine being configured to count a number of inserted coins for each denomination, a memory that stores a first number indicating a total number of coins that can be accepted in a single transaction for each denomination, and a processor configured to: acquire, from the change machine, a number of coins inserted in a transaction for each denomination, determine whether the number of the inserted coins exceeds the first number for each denomination, and upon determining that the number of the inserted coins exceeds the first number for a denomination, control the change machine to dispense a second number of coins of the denomination exceeding the first number.

### CROSS-REFERENCE TO RELATED APPLICATION(S)

This application is based upon and claims the benefit of priority from Japanese Patent Application No. 2022-111394, filed Jul. 11, 2022, the entire contents of which are incorporated herein by reference.

### FIELD

Embodiments described herein relate generally to a checkout device, a method carried out by a checkout device, and a non-transitory computer readable medium.

### BACKGROUND

In a commercial facility such as a grocery store, there is known a Point of Sales (POS) system in which a store clerk performs commodity registration for to-be-purchased commodities and a customer performs a checkout process for the registered commodities using a checkout device, or a customer performs both the commodity registration and the checkout process for the commodities. In such a system, some customers pay or deposit a large amount of coins into the checkout device in a single transaction. A semi-self-service or self-service checkout device is usually equipped with an automatic change machine and can count the coins that have been deposited.

However, since such a checkout device is not designed to receive a large amount of coins or bills in a single transaction, clogging and overflow can occur if a large amount of coins or bills is deposited at once, and store employees need to address those issues. Therefore, the number of coins or bills that can be deposited into the checkout device in a transaction must be limited for each denomination. On the other hand, if the number of coins or bills that can be deposited in a transaction is always limited for each denomination, it is inconvenient for a store clerk to perform a replenishment operation or the like in which a substantial amount of coins or bills is deposited.

### SUMMARY OF THE INVENTION

Embodiments of the present invention provide a technique that makes it possible to limit the number of coins and bills of the same denomination that can be paid by a customer in a single transaction.

In one embodiment, a checkout device includes a change machine into which coins can be inserted and from which coins can be dispensed. The change machine is configured to count a number of inserted coins for each denomination. The checkout device further includes a memory that stores a first number indicating a total number of coins that can be accepted in a single transaction for each denomination, and a processor. The processor is configured to acquire, from the change machine, a number of coins inserted in a transaction for each denomination, determine whether the number of the inserted coins exceeds the first number for each denomination, and upon determining that the number of the inserted coins exceeds the first number for a denomination, control the change machine to dispense a second number of coins of the denomination exceeding the first number.

### BRIEF DESCRIPTION OF THE DRAWINGS

FIG. 1 is a hardware block diagram of a POS terminal according to an embodiment.

FIGS. 2-4 depict cash payment screens displayed on a display device of the POS terminal.

FIG. 5 depicts a receipt printed by the POS terminal.

FIGS. 6 and 7 are flowcharts of checkout processes performed by the POS terminal.

FIGS. 8 and 9 are flowcharts of display processes performed by the POS terminal.

FIG. 10 is a diagram for explaining a mode switching operation according to an embodiment.

FIG. 11 is a perspective view of the POS terminal.

### DETAILED DESCRIPTION

Hereinafter, embodiments will be described in detail with reference to the drawings. In the drawings, the same components are denoted by the same reference numerals as much as possible, and redundant description will be omitted.

(Configuration Example)

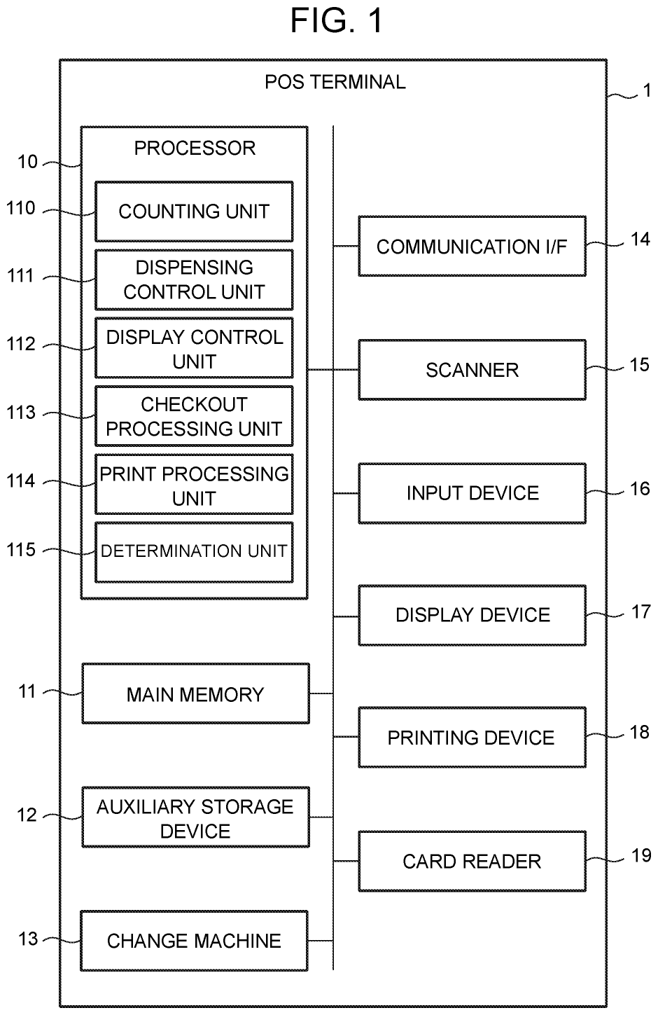

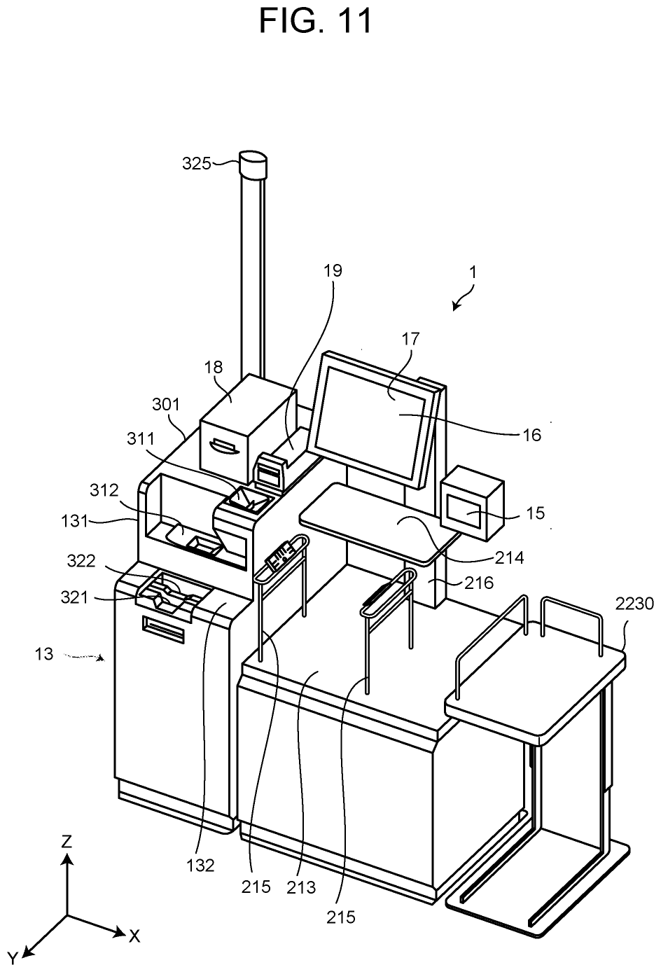

FIG. 1 is a hardware block diagram of a POS terminal 1 according to an embodiment. An external view of the POS terminal 1 is shown in FIG. 11. In the present embodiment, the POS terminal 1 is a self-service checkout device that performs a checkout process based on a customer's own operation. The checkout process of a commercial transaction is, for example, a process of paying the price of a commodity purchased by a customer. The commercial transaction may not involve the buying or selling of the commodity. For example, the POS terminal 1 may be a payment terminal for a customer to pay a service fee for a provided service or a rental fee for a rented item.

The POS terminal 1 performs a process of registering a commodity to be purchased by a customer in addition to the payment process. The registration process is a process of registering sales data of a commodity purchased by a customer in a memory. The POS terminal 1 calculates a billing amount of the commercial transaction based on the sales data. The POS terminal 1 may retrieve a price of a commodity to be purchased by the customer. The commercial transaction includes a process related to registration of a commodity, a process related to checkout of a registered commodity, and a process related to charging of electronic money.

As a means for retrieving a price, a scanner 15 for reading a bar code attached to a commodity and an input device 16, which will be described later, are widely used. Further, a method of referring to the price of the commodity stored in a commodity master file or the like based on the commodity code read from the barcode may be used.

The POS terminal 1 is an electronic device including a processor 10, a main memory 11, an auxiliary storage device 12, a change machine 13, a communication interface (I/F) 14, a scanner 15, an input device 16, a display device 17, a printing device 18, and a card reader 19. The processor 10, the main memory 11, the auxiliary storage device 12, the change machine 13, the communication interface 14, the scanner 15, the input device 16, the display device 17, the printing device 18, and the card reader 19 are connected to each other so that signals can be input and output.

The processor 10 is, for example, a Central Processing Unit (CPU). The processor 10 may be configured by various circuits. The processor 10 loads a program stored in advance in the auxiliary storage device 12 onto the main memory 11. The program causes the processor 10 of the POS terminal 1 to perform various functions of units to be described later. The processor 10 executes various operations by executing the program loaded onto the main memory 11.

The main memory 11 includes a nonvolatile memory area and a volatile memory area. The non-volatile memory area of the main memory 11 stores an operating system and/or programs. The volatile memory area of the main memory 11 is used as a work area in which data is rewritten by the processor 10. For example, the main memory 11 includes Read Only Memory (ROM) as a non-volatile memory area. For example, the main memory 11 includes Random Access Memory (RAM) as a volatile memory area.

The auxiliary storage device 12 is Electric Erasable Programmable Read-Only Memory (EEPROM®), Hard Disc Drive (HDD), or Solid State Drive (SSD). The auxiliary storage device 12 stores the above-described programs, data used by the processor 10 in performing various types of processing, and data generated by processing by the processor 10.

When coins are inserted into the change machine 13 by an operator, the change machine 13 sorts the coins by denomination and calculates the inserted or deposited amount. Hereinafter, “insert” and “deposit” are interchangeably used. The coins sorted by denomination are stored in the storage. On the other hand, when coins need to be dispensed, the change machine 13 removes the coins of the corresponding denomination from the storage. The change machine 13 dispenses the removed coins. The operator may be a customer, a store clerk, a user, or a person. The change machine 13 may perform the same processing on bills.

The communication interface 14 includes various interfaces for communicably connecting the POS terminal 1 to other electronic devices via a network according to a predetermined communication protocol.

The scanner 15 is a device that reads various code symbols and acquires information from the code symbols. For example, the code symbol may be a barcode symbol or a two-dimensional code symbol. The code symbol may include a code symbol of a commodity by which a code for identifying the commodity is represented. The code symbol of the commodity is an image attached to the commodity. The code symbol may include a code symbol for code payment.

The input device 16 is capable of receiving an instruction to the POS terminal 1. For example, the input device 16 may include a keyboard. The input device 16 may constitute a touch screen together with the display device 17.

The display device 17 is capable of displaying various images under the control of the processor 10. For example, the display device 17 is a liquid crystal display or an Electroluminescence (EL) display. The display device 17 may include a sound device that outputs sound.

The printing device 18 prints a receipt. For example, the printing device 18 is a thermal printer, an inkjet printer, or the like.

The card reader 19 reads the card data recorded on the magnetic stripe of the card medium.

As illustrated in FIG. 11, the POS terminal 1 further comprises a bagging base 213 for a customer to bag purchased commodities, a table 214 on which the customer can place a commodity for scan operation, a pair of bag supporting parts 215 for hanging a shopping bag, and a supporting rod 216 for supporting the table 214 under the display device 17.

The change machine 13 has its own chassis 301 and comprises a coin change machine 131 with a coin insertion port 311 and a coin discharge port 312, and a bill change machine 132 with a bill insertion port 321 and a bill discharge port 322. At the top of the change machine 13, a lamp 325 may be disposed.

The hardware configuration of the POS terminal 1 is not limited to the above-described configuration. One or more of the above-described components of the POS terminal 1 may be omitted or modified, and one or more new components may be added thereto as appropriate.

Each unit implemented in the above-described processor 10 will be described.

The processor 10 performs the functions of a counting unit 110, a dispensing control unit 111, a display control unit 112, a checkout processing unit 113, a print processing unit 114, and a determination unit 115. Those units may be referred to as respective functions. The function of each unit can be performed by the processor 10 executing the program loaded onto the main memory 11.

The counting unit 110 determines whether coins have been deposited for payment in a commercial transaction by a user. The counting unit 110 counts the number of coins for each denomination for payment in a commercial transaction. The counting unit 110 sorts the coins that have been deposited by the user by denomination, and counts the amount of coins by denomination. The counting unit 110 may calculate the deposited amount based on the counted number of inserted coins. The counting unit 110 may count the amount of payment according to the denomination of bills inserted by the user.

The dispensing control unit 111 performs control so as to dispense the number of coins exceeding a threshold value among the coins of the same denomination when the number of deposited coins of the same denomination counted by the counting unit 110 exceeds the threshold value. The threshold value indicates, for example, the number of coins for each denomination that can be accepted in one commercial transaction. For example, the threshold value is 20 or the like. In an example, the dispensing control unit 111 dispenses the number of coins exceeding the threshold value every time it is determined that the number of coins exceeds the threshold value. In another example, the dispensing control unit 111 controls to dispense the number of coins exceeding the threshold value after the payment process of the commercial transaction. In this case, the dispensing control unit 111 performs an overflow process. The overflow process includes storing the number of coins exceeding the threshold value for each denomination in the auxiliary storage device 12. The overflow process includes storing an amount corresponding to the number of coins exceeding the threshold value for each denomination in distinction from the payment amount of the change based on the checkout process. The number of coins exceeding the threshold value for each denomination is also referred to as overflow coins. The amount corresponding to the number of coins exceeding the threshold for each denomination is also referred to as an overflow amount or an overflow dispensing amount.

The dispensing control unit 111 performs cancellation process based on an input of a payment cancellation instruction. The dispensing control unit 111 performs a process of canceling a commercial transaction based on the determination unit 115 that will be described later that determines that an instruction to cancel a payment has been input. The process of canceling the commercial transaction includes a process of controlling to dispense the deposited coin. The process of canceling the commercial transaction includes a process of dispensing coins of the same denominations as the ones deposited. The dispensing control unit 111 performs control to dispense the change based on the payment process of the commercial transaction.

The dispensing control unit 111 switches the setting of the threshold value in response to a switching of the transaction mode. The dispensing control unit 111 performs a transaction mode switching process based on a determination that a transaction mode switching instruction has been input by a determination unit 115 to be described later. The transaction mode includes a self-service transaction mode in which a customer deposits money for payment in a commercial transaction, a normal transaction mode in which a store clerk deposits money for processing of a commercial transaction, a face-to-face transaction mode in which the commodity registration is performed by a store clerk and the checkout is performed by a customer using the POS terminal 1 as a conventional full-service POS terminal, a maintenance mode in which the store clerk replenishes coins or bills, and the like.

The display control unit 112 controls display of the display device 17. The display control unit 112 controls the display device 17 to display or notify a warning message when the number of deposits in the same denomination counted by the counting unit 110 exceeds another threshold value having a value smaller than the above-described threshold value. The display control unit 112 controls the display device 17 to display a message related to the threshold value when the number of deposits in the same denomination counted by the counting unit 110 exceeds the threshold value. The display control unit 112 controls the display device 17 to display the number of coins to be dispensed on the display device 17 in a manner that can be distinguished from dispensing based on the payment process of the commercial transaction.

The checkout processing unit 113 processes checkout of a commercial transaction based on an input of a checkout instruction by the user. The checkout processing unit 113 determines whether a checkout instruction is input by the user. The checkout processing unit 113 processes the checkout of the commercial transaction according to the selection of the payment method by the user based on the input of the checkout instruction. The payment method includes offline payment and online payment. The offline payment is a payment in which the POS terminal 1 does not need to cooperate with other electronic devices through the network. For example, the offline payment uses cash, a gift certificate, or the like. The online payment is a payment executed by the POS terminal 1 in cooperation with another electronic device that passes through the network. For example, the online payment is a credit card payment, an electronic money payment, a debit card payment, a code payment, or the like. The checkout process is also referred to as the payment process.

The print processing unit 114 controls printing of a purchase receipt based on the checkout process of the commercial transaction by the checkout processing unit 113.

The determination unit 115 performs various determination processes. The determination unit 115 determines whether the number of bills/coins of the same denomination counted by the counting unit 110 exceeds a threshold value. The determination unit 115 determines whether the number of bills/coins of the same denomination counted by the counting unit 110 exceeds another threshold value having a value smaller than the threshold value. The other threshold value indicates, for example, the number of bills/coins smaller than the number of bills/coins of each denomination that can be accepted in one commercial transaction. For example, when the threshold value is 20, the other threshold value may be 14 or the like. The determination unit 115 determines whether an instruction to end the process has been input by the user. The determination unit 115 terminates the process of the commercial transaction based on the input of an instruction to terminate the process by the user. The determination unit 115 determines whether an instruction to cancel payment has been input by the user. The determination unit 115 determines whether an instruction to switch the transaction mode has been input by the user. The threshold value and the other threshold value may be set in advance or may be appropriately set or updated by an administrator or the like.

A cash payment screen will be described. The display control unit 112 causes the display device 17 to display the cash payment screen when a cash payment is selected by the user on a payment selection screen (not shown).

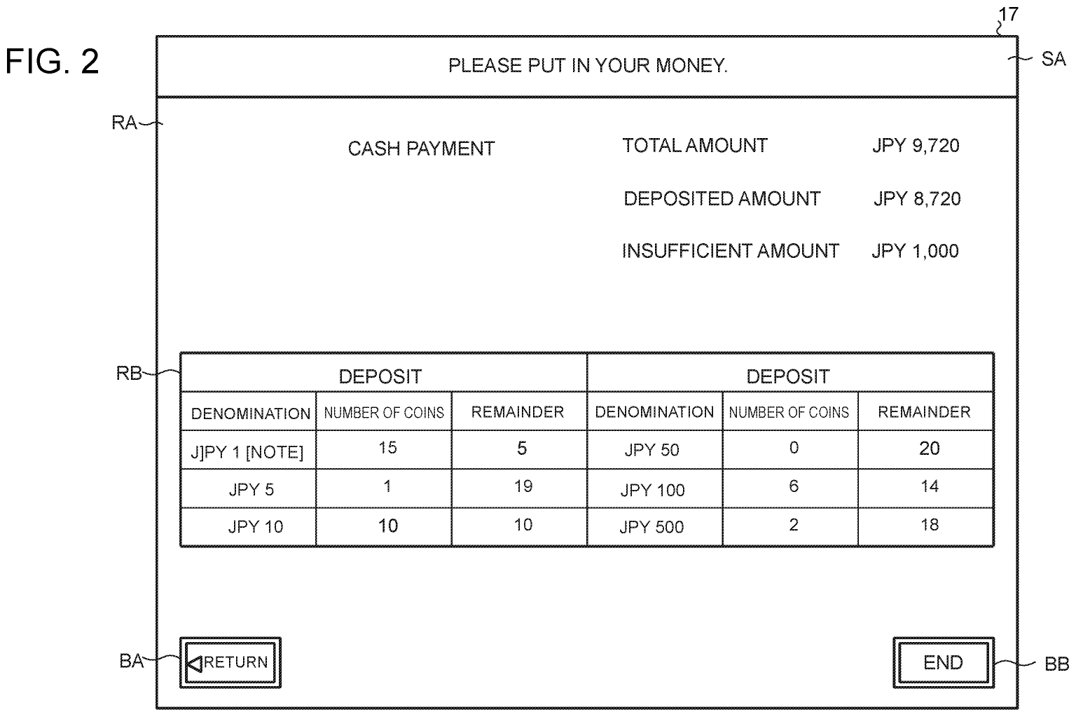

FIG. 2 depicts a cash payment screen SA displayed on the display device 17 of the POS terminal 1.

The cash payment screen SA includes an area RA indicating information related to cash payment, an area RB indicating information related to the deposited coins, a return button BA, and an end button BB. The area RA includes a total amount area, a deposited amount area, and an insufficient amount area. The total amount area displays the total amount. The deposited amount area displays the current deposited amount. In the insufficient amount area, the difference between the total amount and the deposited amount is displayed. The insufficient amount area may display a difference between the total amount and the amount accepted as the deposited amount. The amount of money accepted as the deposited amount is calculated based on the number of received coins when the number of coins for each denomination does not exceed the threshold value. The amount of money accepted as the deposited amount is calculated by subtracting the number of coins exceeding the threshold from the number of coins deposited in the case where the number of deposited coins for each denomination exceeds the threshold. The information related to the received coins includes the number of the received coins, information indicating the relationship between the received coins and the threshold value, information related to the coins to be dispensed, and the like.

The area RB includes a table with a denomination column, a number of coins column, and a remainder column. The denomination column displays the denomination of each coin. In the number of coins column, the number of coins deposited by denomination is displayed. The remainder column displays the remaining number of coins for each denomination of the received coins. The remainder is the number obtained by subtracting the number of deposited coins from the threshold value. The remainder is also referred to as the number of coins that can be deposited until the threshold value is reached.

The denomination column may include an indication of a warning based on the threshold value or another threshold value that is less than the threshold value. For example, the denomination column may include a text display such as “Note” when the number of deposited coins exceeds the other threshold value smaller than the threshold value. The denomination column may include a text display such as “Warning” when the number of deposited coins exceeds the threshold value. The display indicating the warning is not limited to the text display, and may be a symbol or an icon. The warning text may be displayed using a particular color, size, or font from the other text. The warning text may be enclosed by a text box or any figure. The warning text is displayed with a particular brightness or luminance, a particular background color having a particular brightness or luminance, a background pattern, a frame color, a blinking display, and the like. The display indicating the waring is not limited to the denomination column, and may be made at any location in the cash payment screen SA. The area RB may be displayed at the time of transitioning to the cash payment screen SA, or may be displayed when the number of deposits exceeds another threshold value that is smaller than the threshold value. In FIG. 2, 15 one-yen (one Japanese Yen or JPY) coins are deposited, and the remaining number up to the threshold value is 5. In FIG. 2, since the deposit number of one-yen coins exceeds another threshold value smaller than the threshold value, “Note” is shown as a display indicating a warning in the column of one-yen coins. The same applies to coins of other denominations.

The return button BA is a button for transitioning to the payment selection screen. The end button BB ends the payment process.

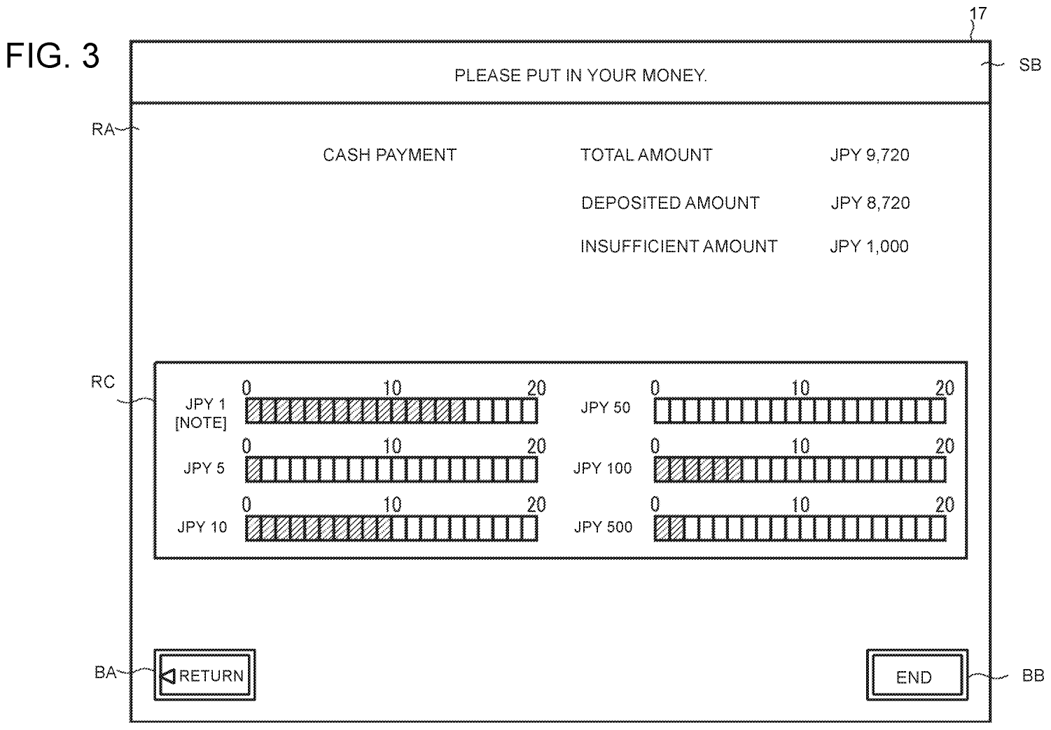

FIG. 3 depicts another cash payment screen SB displayed on the display device 17 of the POS terminal 1.

The cash payment screen SB includes an area RA indicating information related to cash payment, an area RC indicating information related to the deposited coins, a return button BA, and an end button BB. The area RA, the return button BA, and the end button BB are similar to the cash payment screen SA.

The area RC displays the number of coins for each denomination as indicators. For example, in a case where the number of deposited one-yen coins is fifteen, up to the scale indicating fifteen coins may be displayed in different colors or the like. The area RC may indicate warnings based on the threshold value or the other threshold less than the threshold value, similar to the cash payment screen SA. FIG. 3 shows that fifteen one-yen coins have been deposited, one five-yen coin has been deposited, and ten ten-yen coins have been deposited. The same applies to coins of other denominations.

The area RC may display a countdown indicating the number of coins up to the threshold values. The display of the countdown may be a number or an indicator.

The area RC may be displayed at the time of transitioning to the cash payment screen SB, or may be displayed when the number of deposited coins exceeds the other threshold value that is smaller than the threshold value.

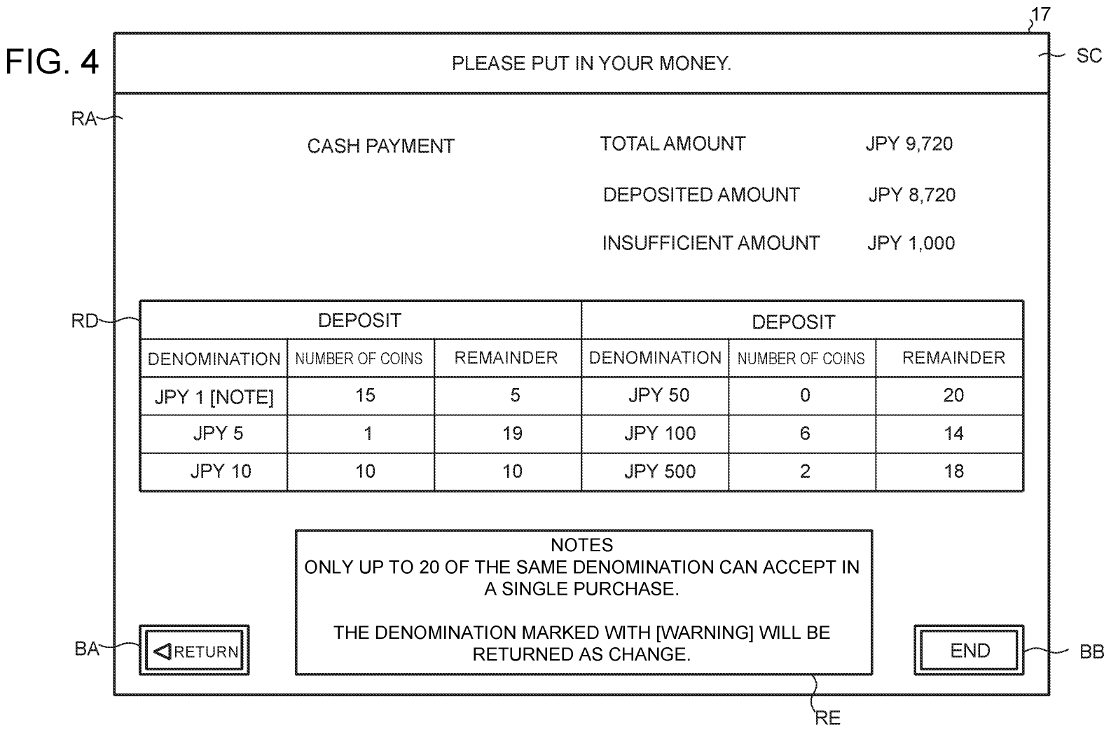

FIG. 4 depicts another cash payment screen SC displayed on the display device 17 of the POS terminal 1.

The cash payment screen SC includes an area RA indicating information related to cash payment, an area RD indicating information related to the deposited coins, a notification area RE, a return button BA, and an end button BB. The area RA, the return button BA, and the end button BB are similar to the cash payment screen SA. The area RD is the same as the area RB of the cash payment screen SA, but may be the same as the area RC of the cash payment screen SB.

The notification area RE displays a waring message. The warning message may include a message notifying the customer of the number of deposited coins that can be accepted. The warning message may include a message notifying the customer that the coins exceeding the number of coins receivable is to be dispensed. The warning message may include a message notifying that the number of deposited coins exceeds a threshold value. The warning message may include a message notifying that the number of deposited coins has exceeded the other threshold value. The warning message may include, for example, “Only up to 20 of the same denomination is accepted in a single purchase.”, “The denomination marked with [NOTE] will be returned with change.” etc.

The notification area RE may be displayed at the time of transitioning to the cash payment screen SC, or may be displayed when the number of deposited coins exceeds the other threshold value.

A receipt printed by the printing device 18 will be described.

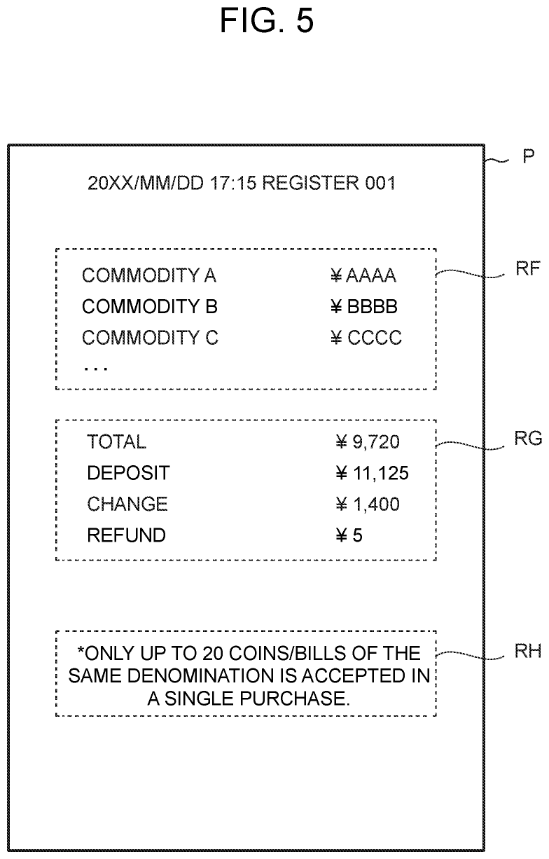

FIG. 5 depicts a receipt P printed by the POS terminal according to an embodiment. The receipt P includes an area RF, an area RG, and an area RH.

The area RF includes information such as a name, a price, and the like of the purchased commodity. The area RG includes cash payment information. The area RG includes information such as a total amount, a deposit amount, change, and a refund. The deposit amount indicates the sum of the deposit amounts received from the customer. The change indicates an amount obtained by subtracting the deposit amount from the total amount. The refund indicates the amount of money obtained by subtracting the amount of receivable money from the amount of deposited money. For example, a case will be described in which the total amount is 9,720 JPY and the total amount of money deposited by the customer is 11,125 JPY. In this example, it is assumed that the customer has deposited 21 coins exceeding 20 coins, which is a threshold value capable of accepting five-yen coins. In this case, twenty five-yen coins are receivable money, and one five-yen coin is non-receivable money. Therefore, the receivable amount is 11,120 yen, and the amount of money “5 JPY” obtained by subtracting the receivable amount from the total amount is calculated as the refund amount. In this example, the amount of change and the amount of money to be refunded as being unacceptable are displayed in an identifiable manner. The denomination of the coin that cannot be accepted and are to be refunded may be displayed in an identifiable manner. In a case where one five-yen coin is refunded, it may be displayed that the number of five-yen coins to be refunded is one.

The area RH displays a waring message. The warning message may include a message notifying the customer of the number of deposits that can be accepted. The warning message may include a message notifying the customer that the number of coins exceeding the number of deposits receivable is to be dispensed. The warning message may include a message notifying that the number of deposits exceeds a threshold value. The warning message may include a message notifying that the number of deposits has exceeded another threshold value. The warning message may include, for example, “Only up to 20 of the same denomination is accepted in a single purchase.”, “The number of coins exceeding the acceptable number will be refunded,” and the like.

(Operation Example)

Next, an exemplary operation of the POS terminal 1 configured as described above will be described.

The process described below is merely an example, and each step may be changed. Further, one or more of the steps can be omitted or replaced, and one or more steps can be added as appropriate with respect to the processing procedure described below.

Here, an example in which a user X purchases a commodity at a store A will be described. The store A processes a commercial transaction for the user X. In the store A, it is assumed that the number of coins that can be accepted in one commercial transaction for each denomination is set to 20. In this case, it is assumed that the threshold value is 20. Further, in the store A, when the number of coins of each denomination inserted in one commercial transaction exceeds 14 and reaches 15, a warning message is notified. In this case, it is assumed that the other threshold value smaller than the threshold value is 14. In this example, it is assumed that the number of coins deposited by the user X is counted.

At the store A, the user X uses the scanner 15 of the POS terminal 1 to register one or more commodities in a commercial transaction. It is assumed that the user X inputs a checkout instruction regarding the commercial transaction of the user X via the input device 16 after the registration of each commodity in the commercial transaction. The checkout instruction is an instruction for starting processing of a commercial transaction by the checkout processing unit 113. Here, it is assumed that the user X selects a cash payment as the payment method. The user X selects cash payment and deposits cash into the POS terminal 1. In the following description, a case where coins are deposited by the user X will be described as an example.

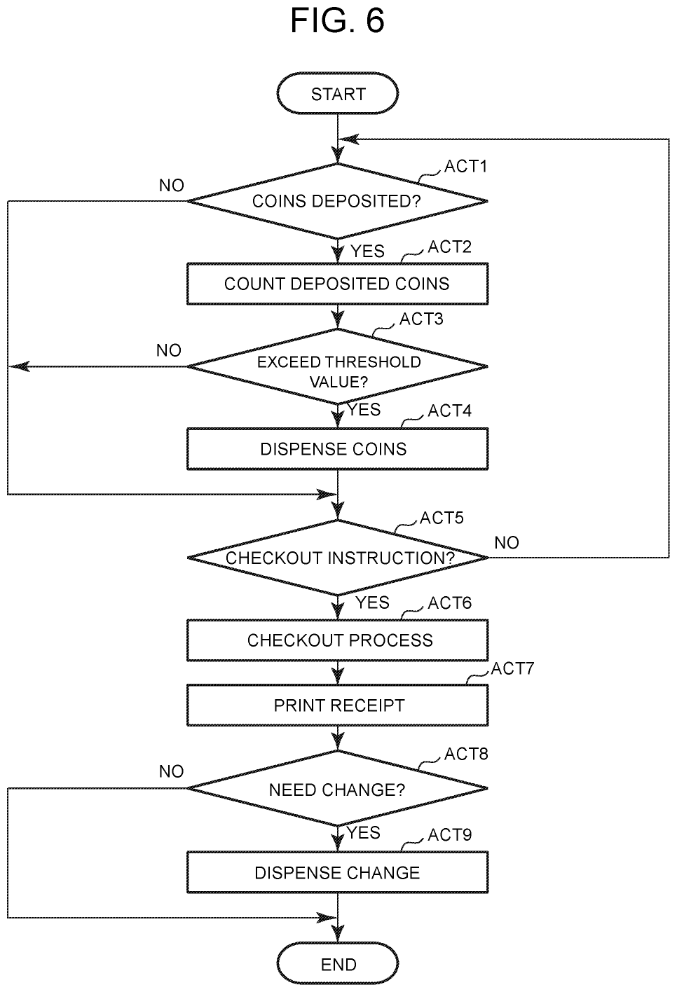

FIG. 6 is a flowchart of a checkout process performed by the processor of the POS terminal 1.

The counting unit 110 determines whether a coin has been deposited for payment in a commercial transaction by the user (ACT1). When the counting unit 110 determines that the deposit has been made (ACT1:YES), the process transitions from ACT1 to ACT2. When the counting unit 110 determines that deposit has not been made (ACT1:NO), the process transitions from ACT1 to ACT5.

The counting unit 110 counts the number of deposited coins for each denomination (ACT2). The counting unit 110 counts the number of deposited coins for each denomination of coins using a known technique.

The determination unit 115 determines whether the number of deposited coins of the same denomination counted by the counting unit 110 exceeds a threshold value (ACT3). When the determination unit 115 determines that the number of deposited coins of the same denomination exceeds the threshold value (ACT3:YES), the process transitions from ACT3 to ACT4. When it is determined that the number of deposited coins of the same denomination does not exceed the threshold value (ACT3:NO), the process transitions from ACT3 to ACT5.

When the determination unit 115 determines that the number of deposited coins of the same denomination exceeds the threshold value, the dispensing control unit 111 controls to dispense the number of coins exceeding the threshold value among the coins of the same denomination (ACT4). For example, a case where the user X inserts 21 five-yen coins will be described. When the determination unit 115 determines that the number of deposited five-yen coins has exceeded the threshold value, i.e., “20 coins”, the dispensing control unit 111 controls to dispense one five-yen coins. Based on the control of the dispensing control unit 111, the change machine 13 dispenses the number of coins exceeding the threshold value. In this example, the change machine 13 dispenses one five-yen coin. Each time the determination unit 115 determines that the number of deposited coins exceeds the threshold value, the dispensing control unit 111 controls to dispense the number of coins exceeding the threshold value.

The checkout processing unit 113 determines whether a checkout instruction is input by the user (ACT5). For example, the checkout processing unit 113 determines whether a checkout instruction has been input based on an input of a checkout instruction button or the like via the input device 16 by the user. When the checkout processing unit 113 determines that a checkout instruction has been input (ACT5:YES), the processing transitions from ACT5 to ACT6. When the checkout processing unit 113 determines that a checkout instruction has not been input (ACT5:NO), the process returns from ACT5 to ACT1.

The checkout processing unit 113 processes the checkout of the commercial transaction based on the input of the checkout instruction by the user (ACT6). The checkout processing unit 113 performs the checkout process based on a known technique. In this example, since the payment by cash is selected by the user X, the checkout process by cash payment is performed.

The print processing unit 114 controls the printing of the purchase receipt based on the checkout process of the commercial transaction by the checkout processing unit 113 (ACTT). When the payment process is performed by the dispensing control unit 111 in ACT4, the print processing unit 114 may print the amount of dispensed money because the amount of money exceeds the threshold value in the purchase receipt. For example, in the above-described example, the print processing unit 114 may print “5 JPY” as the dispensed amount. The print processing unit 114 may print the number of coins for each denomination that has been dispensed. For example, in the above-described example, the print processing unit 114 may print “one” as the number of five-yen coins dispensed.

The checkout processing unit 113 determines whether there is a change as a result of the checkout process based on the cash payment (ACT8). When the checkout processing unit 113 determines that there is any change (ACT8:YES), the processing transitions from ACT8 to ACT9. When the checkout processing unit 113 determines that there is no change (ACT8:NO), the process ends.

When the checkout processor 113 determines that there is any change, the payment controller 111 controls to dispense the change (ACT9). In ACT9, the change machine 13 dispenses the change, for example, under the control of the dispensing control unit 111.

The dispensing control unit 111 performs a cancellation process based on an input of a payment cancellation instruction by the user. The determination unit 115 determines whether an instruction to cancel payment has been input by the user. The dispensing control unit 111 controls to dispense the amount of money corresponding to the deposited coins when the determination unit 115 determines that the cancellation instruction has been input. In this case, the dispensing control unit 111 may be controlled so as to dispense the deposited coins of each denomination. For example, when the cancellation instruction is input after ten one-yen coins and ten five-yen coins have been deposited by the user X, the dispensing control unit 111 may dispense ten one-yen coins and ten five-yen coins, the amount of which is 60 JPY.

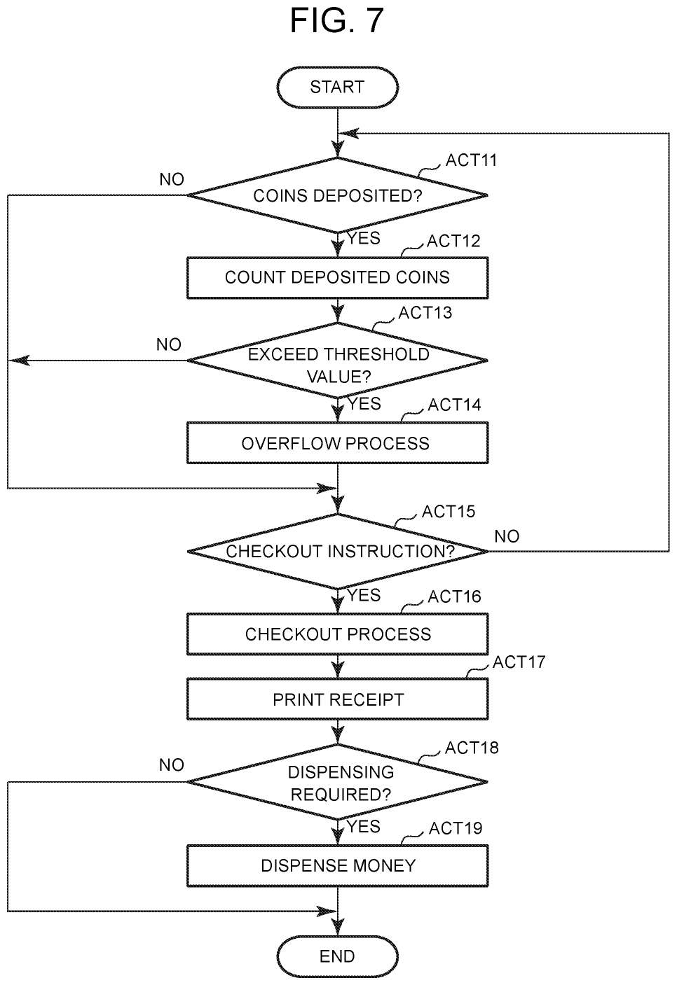

FIG. 7 is another flowchart of a process performed by the processor of the POS terminal 1.

In this example, when the determination unit 115 determines that the number of coins of the same denomination exceeds the threshold value, the dispensing control unit 111 performs control such that the number of coins exceeding the threshold value is dispensed after the checkout process of the commercial transaction.

Similarly to ACT1, the counting unit 110 determines whether coins have been deposited for payment in a commercial transaction by the user (ACT11). When the counting unit 110 determines that the deposit has been made (ACT11:YES), the process transitions from ACT11 to ACT12. When the counting unit 110 determines that deposit has not been made (ACT11:NO), the process transitions from ACT11 to ACT15.

Similarly to ACT2, the counting unit 110 counts the number of coins for each denomination based on the deposit of coins for payment in the commercial transaction (ACT12).

Similar to ACT3, the determination unit 115 determines whether the number of deposited coins of the same denomination counted by the counting unit 110 exceeds a threshold value (ACT13). When the determination unit 115 determines that the number of deposited coins of the same denomination exceeds the threshold value (ACT13:YES), the process transitions from ACT13 to ACT14. When it is determined that the number of deposited coins of the same denomination does not exceed the threshold value (ACT13:NO), the process transitions from ACT13 to ACT15.

When the determination unit 115 determines that the number of deposited coins of the same denomination exceeds the threshold value, the dispensing control unit 111 performs an overflow process (ACT14). In ACT14, for example, the dispensing control unit 111 stores the number of coins exceeding the threshold values for each denomination in the auxiliary storage device 12. For example, a case where the user X inserts 21 five-yen coins will be described. The determination unit 115 determines that the deposit number of five-yen coins exceeds the threshold value “20”. Based on the determination by the determination unit 115, the dispensing control unit 111 stores, as the overflow payment amount, the number of coins “one” that exceeds the threshold value among the five-yen coins that have been deposited. For example, when the user X inputs a number of coins exceeding the threshold value in a plurality of denominations, the number of coins exceeding the threshold value for each denomination may be stored as an overflow payment amount. Specifically, a case will be described where the user X inserts 25 one-yen coins and inserts 21 five-yen coins. The dispensing control unit 111 stores five one-yen coins and one five-yen coin as an overflow dispensing amount “10 JPY”. The dispensing control unit 111 may store the overflow payment amount as the number of coins for each denomination constituting the deposited coins, or may store the overflow payment amount regardless of the number of coins for each denomination.

Like ACT5, the checkout processing unit 113 determines whether a checkout instruction has been input by the user (ACT15). When the checkout processing unit 113 determines that a checkout instruction has been input (ACT15:YES), the process transitions from ACT15 to ACT16. When the checkout processing unit 113 determines that a checkout instruction has not been input (ACT15:NO), the process returns from ACT15 to ACT11.

Like ACT6, the checkout processing unit 113 processes the checkout of the commercial transaction based on the input of the checkout instruction by the user (ACT16).

Like ACTT, the print processing unit 114 controls printing of a purchase receipt based on the checkout process of the commercial transaction by the checkout processing unit 113 (ACT17). When the overflow process is performed by the dispensing control unit 111 in ACT14, the print processing unit 114 may print the number of coins exceeding the threshold value on the purchase receipt. For example, when the user X inserts 21 five-yen coins, the print processing unit 114 may print “5 JPY” as the overflow payment amount. For example, in a case where the user X inserts 25 one-yen coins and inserts 21 five-yen coins, the printing processing unit 114 may print “10 Yen” as the overflow payment amount, or may print the number of coins of each denomination exceeding the threshold value such as “5 one-yen coins, one five-yen coin”. When there is change, the print processing unit 114 may print the overflow payment amount in a manner distinguishable from the change.

The dispensing control unit 111 determines whether dispensing is required (ACT18). In an example, the dispensing control unit 111 determines whether there is change as a result of the checkout process based on the payment by cash. In another example, the dispensing control unit 111 determines whether there is an overflow payment amount based on the overflow processing. In another example, the dispensing control unit 111 determines whether payment is necessary based on the result of the checkout process or the overflow process. When the dispensing control unit 111 determines that dispensing is required (ACT18:YES), the process transitions from ACT18 to ACT19. When the dispensing control unit 111 determines that dispensing is not required (ACT18:NO), the process ends.

When the dispensing control unit 111 determines that dispensing is required, the dispensing control unit 111 controls to dispense money corresponding to the dispensing amount (ACT19). In ACT19, for example, the change machine 13 contributes the amount of money corresponding to the dispensing amount under the control of the dispensing control unit 111. In an example, the dispensing control unit 111 performs control to dispense the change. In another example, the dispensing control unit 111 controls the payment of the overflow payment amount. In another example, the dispensing control unit 111 controls the payment of the change and the overflow payment amount. In this example, the dispensing control unit 111 may dispense the overflow payment amount by the number of denominations constituting the payment amount exceeding the threshold value. The dispensing control unit 111 may dispense the overflow dispensing amount regardless of the number of denominations constituting the deposit amount exceeding the threshold. For example, when the user X inserts 25 one-yen coins and inserts 21 five-yen coins, the dispensing control unit 111 may dispense the amount of money composed of 5 one-yen coins and 1 five-yen coin as an overflow dispensing amount. The dispensing control unit 111 may dispense the overflow payment amount “10 yen” regardless of the number of denominations constituting the payment amount exceeding the threshold value.

The dispensing control unit 111 performs cancellation process based on an input of a payment cancellation instruction by the user. The determination unit 115 determines whether an instruction to cancel payment has been input by the user. The dispensing control unit 111 controls to dispense the amount of money corresponding to the deposited coins based on the fact that the determination unit 115 determines that the cancellation instruction has been input. In this case, the payout controller 111 may be controlled so as to dispense the number of deposited coins of each denomination that have been deposited. For example, when cancellation instruction is input after ten one-yen coins and ten five-yen coins have been deposited by the user X, the dispensing control unit 111 may dispense the amount of “60 JPY” deposited by 1 ten one-yen coins and ten five-yen coins.

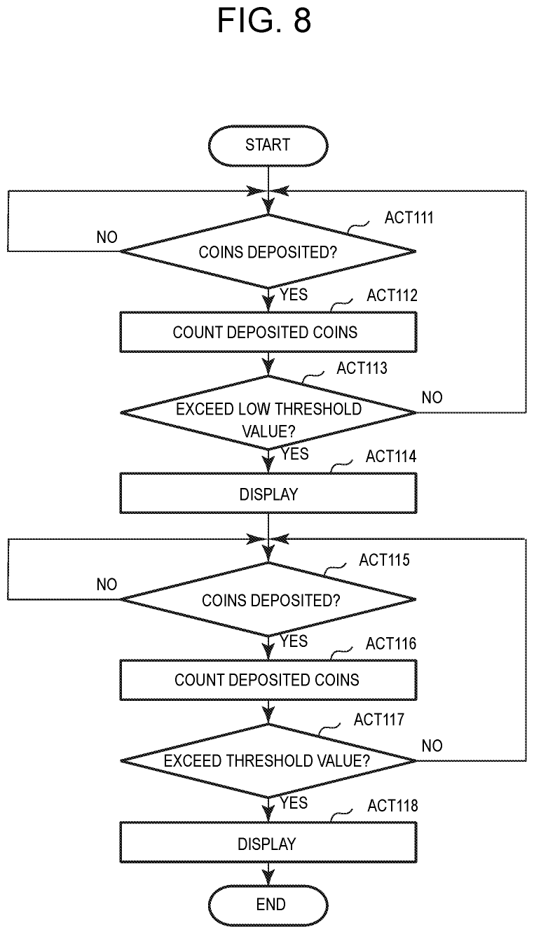

FIG. 8 is a flowchart of a process performed by the processor of the POS terminal 1.

In this example, a screen transition is explained when the user X continues to pay in even if the user X exceeds another threshold value smaller than the threshold value. Each time the determination unit 115 determines that the number of deposited coins exceeds the threshold value, the dispensing control unit 111 controls to dispense the number of coins exceeding the threshold value.

Similarly to ACT1, the counting unit 110 determines whether coins have been deposited for payment in a commercial transaction by the user (ACT111). When the counting unit 110 determines that the deposit has been made (ACT111:YES), the process transitions from ACT111 to ACT112. When the counting unit 110 determines that payment has not been made (ACT111:NO), the process repeats ACT111.

Similarly to ACT2, the counting unit 110 counts the number of deposited coins for each denomination for payment in the commercial transaction (ACT112).

The determination unit 115 determines whether the number of deposited coins of the same denomination counted by the counting unit 110 exceeds another threshold value smaller than the threshold value (ACT113). When the determination unit 115 determines that the number of deposited coins of the same denomination exceeds another threshold value (ACT113:YES), the process transitions from ACT113 to ACT114. When it is determined that the number of deposited coins of the same denomination does not exceed other thresholds (ACT113:NO), the process returns from ACT113 to ACT111.

The display control unit 112 performs ACT114 to control the display device 17 to display a message related to another threshold value when the number of deposited coins in the same denomination counted by the counting unit 110 exceeds another threshold value smaller than the threshold value. The display control unit 112 may control the display device 17 to display a warning message indicating that another threshold value has been exceeded. The display control unit 112 may control the display device 17 to display information related to the deposited coins. For example, the display control unit 112 may control the display device 17 to display the number, the remaining number, and the like of the deposited coins by denomination in an identifiable manner. In an example, as illustrated in FIG. 2, the display control unit 112 may control the display device 17 to display an area including a denomination column, a number of coins column, and a remainder column. In another example, as illustrated in FIG. 3, the display control unit 112 may control the display device 17 to display the number of deposited coins for each denomination using an indicator.

Similarly to ACT111, the counting unit 110 determines whether coins have been deposited for payment in a commercial transaction by the user (ACT115). When the counting unit 110 determines that the deposit has been made (ACT115:YES), the process transitions from ACT115 to ACT116. When the counting unit 110 determines that payment has not been made (ACT115:NO), the process repeats ACT115.

Similarly to ACT112, the counting unit 110 counts the number of deposited coins for each denomination for payment in the commercial transaction (ACT116).

The determination unit 115 determines whether the number of deposited coins of the same denomination counted by the counting unit 110 exceeds a threshold value (ACT117). When the determination unit 115 determines that the number of deposited coins of the same denomination exceeds the threshold value (ACT117:YES), the process transitions from ACT117 to ACT118. When it is determined that the number of deposited coins of the same denomination does not exceed the threshold value (ACT117:NO), the process returns from ACT117 to ACT115.

The display control unit 112 controls the display device 17 to display a message related to the threshold value when the number of deposited coins in the same denomination counted by the counting unit 110 exceeds the threshold value (ACT118). The display control unit 112 may control the display device 17 to display a warning message indicating that the threshold value has been exceeded. In this case, the dispensing control unit 111 dispenses the number of deposited coins for each denomination exceeding the threshold value.

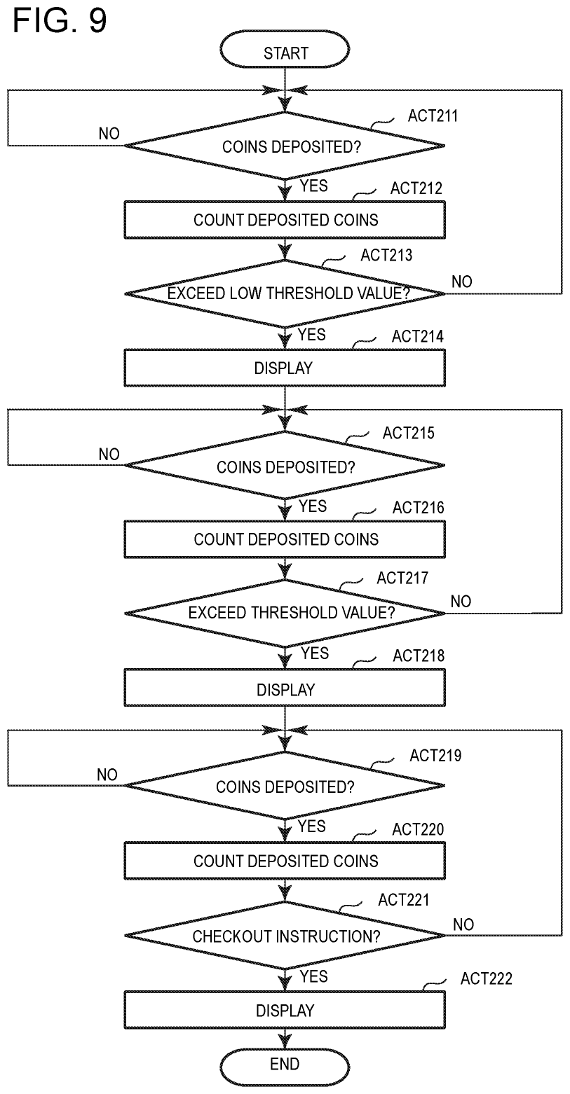

FIG. 9 is another flow chart of a process performed by the processor of the POS terminal 1.

In this example, when the determination unit 115 determines that the number of deposited coins of the same denomination exceeds the threshold value, the dispensing control unit 111 performs control such that the number of coins exceeding the threshold value is dispensed after the checkout process of the commercial transaction.

Similarly to ACT111, the counting unit 110 determines whether coins have been deposited for payment in a commercial transaction by the user (ACT211). When the counting unit 110 determines that the deposit has been made (ACT211:YES), the process transitions from ACT211 to ACT212. When the counting unit 110 determines that payment has not been made (ACT211:NO), the process repeats ACT211.

Similarly to ACT112, the counting unit 110 counts the number of deposited coins for each denomination for payment in the commercial transaction (ACT212).

Similar to ACT113, the determination unit 115 determines whether the number of deposited coins of the same denomination counted by the counting unit 110 exceeds another threshold value that is smaller than the threshold value (hereinafter also referred to as the low threshold value) (ACT213). When the determination unit 115 determines that the number of deposited coins of the same denomination exceeds another threshold value (ACT213:YES), the process transitions from ACT213 to ACT214. When it is determined that the number of deposited coins of the same denomination does not exceed another threshold value (ACT213:NO), the process returns from ACT213 to ACT211.

The display control unit 112 performs ACT214 to control the display device 17 to display a message related to another threshold value when the number of deposited coins of the same denomination counted by the counting unit 110 exceeds another threshold value smaller than the threshold value. The display control unit 112 may control the display device 17 to display a warning message indicating that another threshold value has been exceeded. The display control unit 112 may control the display device 17 to display information related to the received coins. For example, the display control unit 112 may control the display device 17 to display the number, the remaining number, and the like of the deposited coins by denomination in an identifiable manner. In an example, as illustrated in FIG. 2, the display control unit 112 may control the display device 17 to display an area including a denomination column, a number of coins column, and a remainder column. In another example, as illustrated in FIG. 3, the display control unit 112 may control the display device 17 to display the number of deposited coins for each denomination using an indicator.

Similarly to ACT211, the counting unit 110 determines whether coins has been deposited after the display at ACT214 (ACT215). When the counting unit 110 determines that the deposit has been made (ACT215:YES), the process transitions from ACT215 to ACT216. When the counting unit 110 determines that the deposit has not been made (ACT215:NO), the process repeats ACT215.

Similarly to ACT212, the counting unit 110 counts the number of deposited coins for each denomination for payment in the commercial transaction (ACT216).

The determination unit 115 determines whether the number of deposited coins of the same denomination counted by the counting unit 110 exceeds a threshold value greater than the other threshold value used at ACT213 (ACT217). When the determination unit 115 determines that the number of deposited coins of the same denomination exceeds the greater threshold value (ACT217:YES), the process transitions from ACT217 to ACT218. When it is determined that the number of deposited coins of the same denomination does not exceed the threshold value (ACT217:NO), the process returns from ACT217 to ACT215.

The display control unit 112 controls the display device 17 to display a message related to the threshold value when the number of deposited coins of the same denomination counted by the counting unit 110 exceeds the threshold value (ACT218). The display control unit 112 may control the display device 17 to display a warning message indicating that the threshold value has been exceeded.

Similarly to ACT211, the counting unit 110 determines whether coins have been deposited after the display at ACT218 (ACT219). When the counting unit 110 determines that the deposit has been made (ACT219:YES), the process transitions from ACT219 to ACT220. When the counting unit 110 determines that the deposit has not been made (ACT219:NO), the process repeats ACT219.

Similarly to ACT212, the counting unit 110 counts the number of deposited coins for each denomination for payment in the commercial transaction (ACT220). In this case, the display control unit 112 may control the display device 17 to display the number of deposited coins for each denomination counted by the counting unit 110.

Like ACT5, the checkout processing unit 113 determines whether a checkout instruction is input by the user (ACT221). When the checkout processing unit 113 determines that a checkout instruction has been input (ACT221:YES), the process transitions from ACT221 to ACT222. When the checkout processing unit 113 determines that a checkout instruction has not been input (ACT221:NO), the process returns from ACT221 to ACT219.

The display control unit 112 controls the display device 17 to display the number of coins to be dispensed in a manner distinguishable from dispensing based on the payment process of the commercial transaction (ACT222). In ACT222, for example, the display control unit 112 may control the display device 17 to display the change based on the checkout process by the checkout processing unit 113 and the number of coins exceeding the threshold values for each denomination. The number of coins exceeding the threshold indicates coins to be dispensed. The number of coins exceeding the threshold corresponds to the overflow amount of money to be paid out. For example, in a case where the user X inserts 25 one-yen coins and inserts 21 five-yen coins, the display control unit 112 may control the display device 17 to display the number of the denominations exceeding the threshold value such as “five one-yen coins, one five-yen coin”. When there is change, the display control unit 112 may control the display device 17 to display the overflow dispensing amount in a manner distinguishable from the change.

In the flowcharts of FIGS. 6 to 9, when an end instruction is input by the user X, the processor 10 ends the process. For example, the determination unit 115 determines whether an instruction to end the process by the user X has been input. When the determination unit 115 determines that an end instruction has been input, the process ends.

The POS terminal 1 according to the above-described embodiments can count the number of coins of each denomination deposited for payment in a commercial transaction, and when the counted number of coins of the same denomination exceeds a threshold value that can be accepted in one commercial transaction, dispense the number of coins that exceed the threshold value among the coins of the same denomination.

Thus, the POS terminal 1 can dispense the number of coins exceeding the threshold value when the number of coins of the same denomination exceeds the threshold value by the customer. Therefore, it is possible to prevent a large amount of coins of the same denomination from being input by the customer. In this way, the POS terminal 1 can limit the number of deposited coins of the same denomination by the customer. In addition, the POS terminal 1 can prevent a trouble such as a jam caused by a large amount of coins input by a customer.

The POS terminal 1 according to the above-described embodiments may display a message related to another threshold value on the display device 17 when the number of deposited coins of the same denomination exceeds another threshold value smaller than the threshold value. As a result, the POS terminal 1 can notify the customer of the number of coins that can be inserted and warn the customer before the number of coins that can be inserted is reached. Therefore, it is possible to prevent a large amount of coins of the same denomination from being input by the customer. In this way, the POS terminal 1 device can limit the number of coins of the same denomination deposited by the customer.

The POS terminal 1 according to the above-described embodiments can dispense the number of coins exceeding the threshold after the checkout process of the commercial transaction. Thus, the POS terminal 1 can omit the process of dispensing the number of coins exceeding the threshold every time the threshold value is exceeded. Therefore, the POS terminal 1 can simplify the overflow process when the number of coins exceeding the threshold value is inserted. Further, since the customer can receive the dispense at once at the time of the checkout process, the convenience is improved.

The POS terminal 1 according to the above-described embodiments can display the number of coins to be dispensed on the display device 17 in a manner that can be distinguished from the dispensing based on the payment process of the commercial transaction. Thus, the POS terminal 1 can display the number of deposited coins exceeding the threshold value distinguished from the number of dispense for a change. Therefore, the customer can easily recognize whether the coin to be dispensed exceeds the threshold value or is the change. In this way, the POS terminal 1 can improve the convenience of the customer by making the coins to be dispensed identifiable.

The POS terminal 1 according to the above-described embodiments can dispense money according to the deposited coins of the same denomination in response to the input of the cancel instruction of the deposit. Thus, the POS terminal 1 can prevent, for example, a customer from exchanging a small amount of coins for a large amount of coins using the POS terminal 1. Therefore, the POS terminal 1 can restrict the number of coins of the same denomination deposited by the customer.

The POS terminal 1 according to the above-described embodiments can switch the setting of the threshold value in response to the switching of the transaction mode. As a result, the POS terminal 1 can switch the setting of the threshold value by the operation of the store. Therefore, the POS terminal 1 can improve convenience on the store side. In addition, the POS terminal 1 can change or cancel the setting of the threshold value in a maintenance mode or the like in which coins are refilled and deposited. Therefore, the POS terminal 1 can change the limit of the number of coins of the same denomination according to the transaction mode.

### Other Embodiments

In the above-described embodiments, the counting unit 110 counts the number of coins of each denomination deposited by a customer for payment in a commercial transaction, and the dispensing control unit 111 performs control such that, when the number of deposited coins of the same denomination counted by the counting unit 110 exceeds a threshold value, the number of coins exceeding the threshold value among the coins of the same denomination is dispensed. The dispensing control unit 111 may switch the setting of the threshold value in accordance with the switching of the transaction mode. For example, in a normal transaction mode in which a store clerk inserts money for processing a commercial transaction and a face-to-face transaction mode in which the store clerk and the customer operate the POS terminal 1, the setting or non-setting of the threshold value may be appropriately selected. In the case of the maintenance mode in which the store clerk replenishes the POS terminal 1 or the storage of the change machine 13 with coins through the insertion port, the threshold value may be switched to a higher value. For example, in the maintenance mode, the threshold value may be set to 50 or the like.

In the above-described embodiments, as an example of the dispensing method, the POS terminal 1 is configured to dispense the number of coins exceeding the threshold value after the payment process of the commercial transaction. As a modification in this case, a method is conceivable in which the dispensing control unit 111 controls the dispensing method so that coins for change and ones exceeding the threshold value are mixed and dispensed at once. In this case, it is possible to shorten the time required for separately dispensing the change and the number of coins exceeding the threshold. Further, in the dispensing control unit 111, change is dispensed first, and after a sensor provided in the change machine 13 detects that the customer has collected the change, the number of coins exceeding the threshold value can be dispensed. In this case, it is possible to notify the customer of the dispense as change and the dispense as the number of coins exceeding the threshold. The display device 17 can display notifications according to the dispense of the change and the number of coins exceeding the threshold.

In another embodiment, the checkout device may provide a coin selector, which is a mechanism for identifying inserted coins, downstream of the deposit opening of the change machine 13 included in the POS terminal 1. The processor 10 of the POS terminal 1 notifies the coin selector of information indicating the inserted coins of the denomination that exceeds the threshold value. When receiving the information of the denomination from the processor 10, the coin selector detects the coins corresponding to the denomination deposited from the deposit port and exceeding the threshold, and forcibly discharges the coins of the denomination to the outside of the POS terminal 1 through the dispensing port (hereinafter referred to as the reject processing). As a result, for a coin that exceeds the threshold value, the coin can be discharged to the outside by the coin selector before the coin is counted by the counting unit 110. Therefore, the consumer can immediately recognize that the coin exceeding the threshold value cannot be deposited at the timing when the deposit operation is performed.

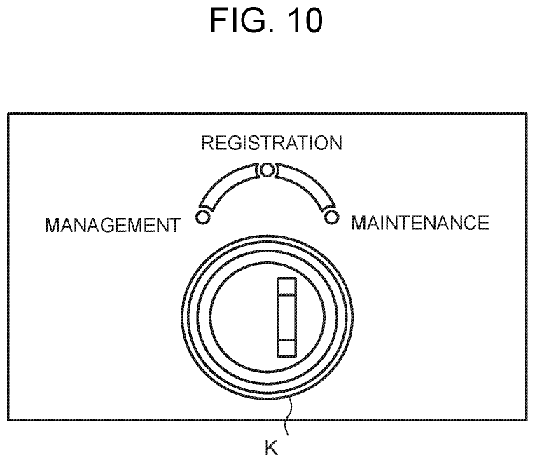

The switching of the transaction mode may be performed based on an operation by a key K as illustrated in FIG. 10. In one embodiment, the key K is disposed on the chassis 301 of the change machine 13. The key K may be disposed at any location on the POS terminal 1. For example, when changing to the maintenance mode, the key K is adjusted to “maintenance”. To change to the registration mode in which the commodity is registered, set the key to “registration”. The determination unit 115 determines whether the number of deposited coins of the same denomination counted by the counting unit 110 exceeds a threshold value based on the threshold value set for each transaction mode.

In the above-described embodiments, the display control unit 112 has described an example of controlling the display device 17 to display a warning message, information related to the deposited coins, and the like, but the present invention is not limited thereto. For example, a warning message may be displayed on a display provided separately from the display device 17, information related to the received coin, and the like. Alternatively, the notification may be performed by a notification unit other than the display, for example, by voice output or the like.

The POS terminal 1 is not limited to a self-service POS terminal. It may be a conventional, full-service POS terminal operated by a store clerk. Further, the registration device for registering the commodity and the checkout device for performing the payment process based on the information of the registered commodity may be separated, and the registration device may be a semi-self-service type POS terminal operated by a store clerk and the checkout device may be operated by a customer.

The change machine 13 may be a machine in which bills and coins are separated from each other. In other words, the POS terminal 1 may be equipped with an automatic change machine dedicated to coins to notify the number of coins to be inserted for each denomination. Similarly, the POS terminal 1 may be equipped with an automatic change machine for bills to notify the number of inserted bills by denomination.

The POS terminal 1 may be one electronic device as described above, or may be a system including a plurality of electronic devices.

The above-recited embodiments focus on counting the coins deposited by a customer. However, the above-recited steps can also be performed on the bills inserted by the customer. In such a case, the POS terminal 1 can display the areas RB, RC, and RD shown in FIGS. 2-4 such that not only the deposited coins but the deposited bills of each denomination (e.g., one-thousand-yen, five-thousand-yen, etc.) are shown. The POS terminal 1 performs the steps shown in FIGS. 6-9 for the deposited bills, too.

The program executed by the processor 10 may be stored in the POS terminal 1 in advance or may be installed separately. In the latter case, the program may be downloaded via a network or may be copied from a non-transitory computer readable recording medium. The recording medium may be any medium that can store programs such as CD-ROM and memory cards and can be read by an electronic device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A checkout device comprising:
a change machine into which coins can be inserted and from which coins can be dispensed, the change machine being configured to count a number of inserted coins for each denomination;
a memory that stores a first number indicating a total number of coins that can be accepted in a single transaction for each denomination; and
a processor configured to:
acquire, from the change machine, a number of coins inserted in a transaction for each denomination,
determine whether the number of the inserted coins exceeds the first number for each denomination, and
upon determining that the number of the inserted coins exceeds the first number for a denomination, control the change machine to dispense a second number of coins of the denomination exceeding the first number.

2. The checkout device according to claim 1, further comprising:
a display device, wherein
the processor is configured to, upon determining that the number of the inserted coins exceeds the first number for a denomination, control the display device to display a message indicating that the number of the inserted coins of the denomination exceeds the first number.

3. The checkout device according to claim 1, wherein the processor is configured to:
process the transaction and calculate change, and
control the change machine to dispense the change before dispensing the second number of coins exceeding the first number.

4. The checkout device according to claim 3, further comprising:
a display device, wherein
the processor is configured to control the display device to display an amount of the change and the second number, separately.

5. The checkout device according to claim 1, further comprising:
an input device through which an instruction to cancel the transaction can be input, wherein
the processor is configured to, in response to the instruction to cancel the transaction, control the change machine to dispense the inserted coins.

6. The checkout device according to claim 1, further comprising:
a key for switching transaction modes including a first mode in which a transaction is processed for a customer and a second mode in which coins are replenished by a store clerk, wherein
the memory stores the first number for each of the transaction modes, and the first number for the first mode is less than the first number for the second mode.

7. The checkout device according to claim 1, further comprising:
a display device, wherein
the processor is configured to control the display device to display a screen showing the number of the inserted coins and a difference between the number of the inserted coins and the first number for each denomination.

8. The checkout device according to claim 7, wherein the screen shows the number of the inserted coins and the difference by a graphical indicator.

9. The checkout device according to claim 7, wherein
the memory stores a third number less than the first number for each denomination, and
the processor is configured to:
determine whether the number of the inserted coins exceeds the third number for each denomination, and
upon determining that the number of the inserted coins exceeds the third number for a denomination, control the display device to display a warning sign indicating that the number of the inserted coins of the denomination is reaching the corresponding first number.

10. The checkout device according to claim 1, further comprising:
a display device, wherein
the processor is configured to control the display device to display both a total amount of the inserted coins and a total amount of coins that can be used in the transaction.

11. A method carried out by a checkout device including a change machine into which coins can be inserted and from which coins can be dispensed, the method comprising:
storing a first number indicating a total number of coins that can be accepted in a single transaction for each denomination;
counting a number of coins inserted in a transaction for each denomination;
determining whether the number of the inserted coins exceeds the first number for each denomination; and
upon determining that the number of the inserted coins exceeds the first number for a denomination, controlling the change machine to dispense a second number of coins of the denomination exceeding the first number.

12. The method according to claim 11, further comprising:
upon determining that the number of the inserted coins exceeds the first number for a denomination, displaying a message indicating that the number of the inserted coins of the denomination exceeds the first number.

13. The method according to claim 11, further comprising:
processing the transaction and calculating change; and
controlling the change machine to dispense the change before dispensing the second number of coins exceeding the first number.

14. The method according to claim 13, further comprising:
displaying an amount of the change and the second number, separately.

15. The method according to claim 11, further comprising:
upon receipt of an instruction to cancel the transaction, controlling the change machine to dispense the inserted coins.

16. The method according to claim 11, wherein
the checkout device includes a key for switching transaction modes including a first mode in which a transaction is processed for a customer and a second mode in which coins are replenished by a store clerk, and
the first number is stored for each of the transaction modes, and the first number for the first mode is less than the first number for the second mode.

17. The method according to claim 11, further comprising:
displaying a screen showing the number of the inserted coins and a difference between the number of the inserted coins and the first number for each denomination.

18. The method according to claim 17, wherein the screen shows the number of the inserted coins and the difference by a graphical indicator.

19. The method according to claim 17, further comprising:
storing a third number less than the first number for each denomination;
determining whether the number of the inserted coins exceeds the third number for each denomination, and
upon determining that the number of the inserted coins exceeds the third number for a denomination, displaying a warning sign indicating that the number of the inserted coins of the denomination is reaching the first number.

20. A non-transitory computer readable medium storing a program causing a computer to execute a method comprising:
storing a first number indicating a total number of coins that can be accepted in a single transaction for each denomination;
counting a number of coins inserted into a change machine in a transaction for each denomination;
determining whether the number of the inserted coins exceeds the first number for each denomination; and
upon determining that the number of the inserted coins exceeds the first number for a denomination, controlling the change machine to dispense a second number of coins of the denomination exceeding the first number.
